(19) United States
(12) Patent Application Publication
(10) Pub. No.: US 2026/0001135 A1
(43) Pub. Date: Jan. 1, 2026

(54) NEAR-ZERO EXPANSION LATTICE METAL BASED ON ADDITIVE MANUFACTURING, AND PREPARATION METHOD AND USE THEREFOR

(71) Applicant: Shenyang Research Institute of Foundry Co., LTD. CAM, Shenyang, Liaoning (CN)

(72) Inventors: Yanpeng Wei, Shenyang (CN); Bo Yu, Shenyang (CN); Jingchang Cheng, Shenyang (CN); Jian Shi, Shenyang (CN); Yingchun Ma, Shenyang (CN); Peng Gao, Shenyang (CN); Zhiquan Miao, Shenyang (CN); Shuwen Guan, Shenyang (CN); Jingcheng Wang, Shenyang (CN)

(21) Appl. No.: 18/842,319

(22) PCT Filed: Jan. 6, 2023
(86) PCT No.: PCT/CN2023/071013

§ 371 Date: Aug. 28, 2024

(30) Foreign Application Priority Data
Oct. 21, 2022 (CN) 202211293075.4

(51) Int. Cl. B22F 10/38; B22F 10/25; B22F 10/34; B33Y 10/00; B33Y 70/00

(52) U.S. Cl. CPC B22F 10/38; B22F 10/25; B22F 10/34; B33Y 10/00; B33Y 70/00

(57) ABSTRACT

Provided in the present invention are a near-zero expansion lattice metal based on additive manufacturing, and a preparation method and use therefor. The lattice metal has a three-dimensional bimetal lattice structure. The lattice metal is formed by expanding bimetal lattice cells. Each bimetallic lattice cell is of a three-dimensional structure having a truss structure embedded in a hexahedron, and has the capability of expanding in three spacial directions. A transition area is arranged at a connection position of the hexahedron and the truss structure, and the contour of the transition area is not larger than a pore-strut diameter of the cell. The hexahedron is a metal, and the truss structure is another metal. The transition area is a mixture of the two metals, and the ratio of linear expansion coefficients of the two metals is not lower than S. Interfaces of the two metals are metallurgically bonded without gaps.

### TECHNICAL FIELD

The present disclosure belongs to the technical field of additive manufacturing of lattice metal, and in particular relates to a lattice metal with near-zero-expansion characteristic and a manufacturing method and application thereof.

### BACKGROUND

In fields such as aeronautics and aerospace, due to the natural property of the material itself that it expands when heated and contracts when cooled, under extreme temperature conditions such as space, the stability, safety and reliability of the structure will be reduced, the service performance of the material will be weakened, and even the functional components of the structure will be damaged. For example, satellites experience alternation of day and night during the working process, and excessive temperature difference will easily lead to thermal stress deformation and thus structural damage. The excessive thermal expansion behavior of communication satellite antenna bracket will affect the normal communication between the antenna and the ground. Therefore, there is an urgent need for structural components with high thermal stability on navigation satellites. exploration satellites and other aeronautics and aerospace equipment.

Thermal expansion coefficient is a core parameter to measure the dimensional change of a material when the temperature changes. The lower thermal expansion coefficient, the smaller deformation of the material when the temperature changes. Near-zero-expansion material refers to a material that produces small geometric size change when subjected to temperature changes, it is insensitive to temperature change, and its thermal expansion coefficient is close to zero. At present, there are two main methods to achieve materials with near-zero-expansion performance: one is to find near-zero-expansion materials existing in nature, and the other is to manufacture composite materials from materials with different thermal expansion coefficients and obtain near-zero-expansion materials by superposition effect. Although a few ceramic materials in nature show near-zero-expansion characteristic, ceramics are difficult to be applied in engineering practice because of their brittleness. low fracture toughness and high processing difficulty. In contrast, the research on near-zero-expansion materials now mainly focuses on the composite manufacturing and structural design of metal materials with different thermal expansion coefficients. The composite manufacturing of bimetallic materials is an important research approach to achieve the near-zero-expansion characteristic of materials. However, due to the interface thermal matching problem, different metallic materials are prone to failure due to thermal stress during extreme temperature changes. In addition, bimetallic materials generally adopt fitting or assembly pattern, and the existence of interface gaps can easily affect the near-zero-expansion characteristic of materials. The pore structure design of lattice metal is an important method to realize the near-zero-expansion characteristic of materials. The near-zero-expansion characteristic of materials can be achieved by methods such as cell design and topology optimization. At present, most of the research focuses on the design of two-dimensional lattice structure. The design of two-dimensional lattice structures can only achieve near-zero-expansion characteristic in the plane, which hinders the practical application of near-zero-expansion lattice metal in engineering. It is urgent to develop the design of three-dimensional lattice structure and the development of manufacturing technology.

Three-dimensional bimetallic lattice structure has complex configuration design and precise processing requirements, and the existing fitting and assembling manufacturing processes are difficult to meet the requirements of three-dimensional bimetallic lattice structure. Additive manufacturing process is changed from process constraint-based design to function-driven design, which can realize the design and manufacturing with structural and functional integration. There is no mold added into the process of additive manufacturing, and it is not restricted by complex shape of the workpiece, which can meet the manufacturing requirements of three-dimensional lattice metal. Among the additive manufacturing methods, the laser coaxial powder feeding additive manufacturing process has the characteristics of coaxial powder feeding and has the potential of printing multiple materials. However, at present, the laser coaxial powder feeding additive manufacturing process mainly focuses on the forming of multiple materials or gradient materials perpendicular to the printing direction (z axis direction), and it is difficult to print different metals parallel to the printing direction (xy plane).

At present, the research on near-zero-expansion metal materials in China is still in its infancy, and most of the research is about ceramic materials and a small number of metal-based composite materials. There are few reports on the design and manufacturing of a three-dimensional isotropic lattice metal with near-zero-expansion in a wide temperature range.

### SUMMARY

In view of the shortcomings of the existing art, the present disclosure provides a near-zero-expansion lattice metal based on additive manufacturing and a manufacturing method and application thereof.

In accordance with an aspect of the present disclosure, a three-dimensional bimetallic lattice structure is designed. Through the synergistic effect of thermodynamic performance difference between two metal materials and deformation of the lattice structure, isotropic near-zero-expansion characteristic in a wide temperature range of the three-dimensional bimetallic lattice structure is achieved.

In accordance with another aspect of the present disclosure, the manufacturing of near-zero-expansion lattice metal is achieved through the laser coaxial powder feeding additive manufacturing process, so that metallurgical bonding at the bimetallic interface of the three-dimensional lattice structure is achieved, and the influence of the gap between the bimetallic interfaces on the performance of the near-zero-expansion characteristic of the structure in the fitting mode is avoided.

The technical solution of the present disclosure is as follows.

A near-zero-expansion lattice metal based on additive manufacturing, the lattice metal has a three-dimensional bimetallic lattice structure. and the lattice metal is formed by extending a bimetallic lattice cell. The bimetallic lattice cell has a three-dimensional structure with a truss structure embedded in a hexahedron, has good spatial extendibility in the three spatial directions. The connection position between the hexahedron and the truss structure is provided with a transition region, and the contour of the transition region is not larger than the linkage diameter of the cell. The hexahedron is made of one type of metal, the truss structure is made of another type of metal, and the transition region is a mixture of the two types of metal. A ratio of linear expansion coefficients of the two types of metals is not less than 5, an interface between the two metals has no gap, and the two type of metals are metallurgically bonded at the interface. A laser coaxial powder feeding additive manufacturing process is adopted to manufacture the lattice metal.

As preferred technical solutions:

The hexahedron is made of Invar alloy and the truss structure is made of NiTi alloy.

The lattice metal has a near-zero-expansion characteristic in a wide temperature range, the wide temperature range is a temperature range of −100° C.˜1000° C., and the near-zero-expansion characteristic is a characteristic that an absolute value of the thermal expansion coefficient is not higher than 0.5×10⁻⁶ K⁻¹ in the wide temperature range; the lattice metal has an isotropic thermodynamic property shown by same near-zero-expansion characteristics in the three spatial directions.

The lattice metal has a porosity of 58%˜92% and a linkage diameter of 1˜3 mm.

The bimetallic lattice cell structure according to the present disclosure has good spatial extendibility, and can ensure a complete connection between cells when a cell extends in the three spatial directions, Parametric modeling on the near-zero-expansion lattice metal is conducted using three-dimensional design software, and the thermal expansion coefficient of lattice metal is calculated using finite element software. By adjusting characteristic parameters such as the diameter of the linkage and the applicable positions of the two metals, an effective regulation of the thermal expansion coefficient of the lattice metal is achieved.

According to another aspect of the present disclosure, a manufacturing method of the lattice metal is provided. The method includes the following steps.

Step 1, carrying out process adaptability design on pore structure for the near-zero-expansion lattice metal with three-dimensional design software, and establishing a three-dimensional model of the bimetallic lattice structure.

Step 2, slicing the three-dimensional model of the near-zero-expansion lattice metal established in step 1 with slicing software, and different process parameters are set in different regions in the same format. A hexahedron structure slicing region corresponds to a first set of process parameters, and the fed powder material is Invar alloy powder; A truss structure slicing region corresponds to a second set of process parameters, and the fed powder material is NiTi alloy powder; A transition region at the connection position of the hexahedron and the truss structure corresponds to a third set of process parameters, and the fed powder material is mixed powder of Invar alloy and NiTi alloy.

Step 3, carrying out three-barrel controlled printing with the laser coaxial powder feeding additive manufacturing process under inert gas atmosphere.

The process parameters for the hexahedron structure slicing region are laser power being 1000˜2500 W, scanning speed being 200˜1400 mm/min, powder feeding airflow being 5˜25 L/min and overlapping ratio being 50%˜70%.

The process parameters for the truss structure slicing region are laser power being 800˜2000 W, scanning speed being 150˜1000 mm/min, powder feeding airflow being 5˜25 L/min and overlapping ratio being 50% ˜70%.

The process parameters for the transition region are laser power being 1000˜2500 W, scanning speed being 50˜600 mm/min, powder feeding airflow being 5˜15 L/min, overlapping ratio being 70%-90%.

The single layer thickness for the three regions is 0.5˜0.7 mm, and the spot diameter is 0.8˜3 mm.

Step 4, carrying out solution treatment on the near-zero-expansion lattice metal obtained in step 3, wherein the temperature for treatment is 1000° C., and the duration for treatment is 1˜10 hours.

As preferred technical solutions:

In step 2, the average particle size of the Invar alloy powder and the NiTi alloy powder is 20˜53 μm; in the mixed powder, the volumetric ratio of the invar alloy and the NiTi alloy is 1:1˜3:1.

In step 3, multi-channel powder design and control software is used to conduct the feeding control of three types of powders and the automatic switching of the barrels, so that associated selection control of powder channels is achieved and the near-zero-expansion lattice metal is prepared.

The near-zero-expansion lattice metal manufactured according to the above method is used to manufacture thermally stable structural components in the aeronautics and aerospace field under extreme environmental service conditions, the thermally stable structural components are preferably camera brackets of new navigation satellites, deep space exploration satellites or aeronautics and aerospace equipment.

Regarding the existing near-zero-expansion materials, the common near-zero-expansion materials are mainly composite materials and two-dimensional lattice metals. The near-zero-expansion characteristic of composite materials mainly depend on the phase transformation mechanism inside the materials, so the near-zero-expansion characteristic only exist at narrow temperature points. The near-zero-expansion characteristic of two-dimensional lattice metals generally exhibit obvious anisotropy, which greatly limits their practical application. According to the present disclosure, a three-dimensional lattice metal with isotropic near-zero-expansion characteristic in a wide temperature range is designed, and the near-zero-expansion lattice metal in a wide temperature range of −100° C.˜1000° C. is manufactured under the protection of inert gas atmosphere through a laser coaxial powder feeding additive manufacturing process, the near-zero-expansion lattice metal having advantages of excellent interface bonding performance and strong designability.

The present disclosure has the following advantages and beneficial effects.
1. Thermal expansion coefficient being approximately zero. According to the present disclosure, through the design of a three-dimensional lattice structure. Invar alloy and NiTi alloy with different thermal expansion coefficients in a certain temperature range are manufactured together, so that the entire material presents a near-zero-expansion characteristic, and the absolute value of the thermal expansion coefficient of the three-dimensional near-zero-expansion lattice metal in an applicable temperature range is not higher than 0.5×10⁻⁶ K⁻¹.
2. Wide temperature range. The narrow allowable temperature range has always been a bottleneck problem that affects the expansion characteristic of materials in practical application. According to the present disclosure, the temperature range of the near-zero-expansion phenomenon of the material is expanded through the design of the bimetallic lattice structure in combination with the additive manufacturing process, and the service temperature range of the near-zero-expansion lattice metal of the present disclosure is −100° C.˜1000° C.
3. Spatial extendibility and isotropy. According to the present disclosure, a bimetallic lattice cell structure with a truss structure embedded in a hexahedron is used, which has a good extendibility. The extended near-zero-expansion lattice metal realizes thermodynamic isotropy in the three directions, which is exhibited by the same thermal expansion coefficient in the three spatial directions.
4. Metallurgical bonding at bimetallic interface. Most of the existing two-dimensional bimetallic lattice structures adopts the fitting pattern, and the existence of interface gap hinders the near-zero-expansion characteristic of the structure. According to the present disclosure, a transition region is arranged at the connection position between the two metals, and the interface between the two metals are metallurgically combined through the laser coaxial powder feeding additive manufacturing process, so that the near-zero-expansion characteristic of the lattice metal material is ensured.

### BRIEF DESCRIPTION OF THE DRAWINGS

FIG. 1 is a schematic diagram of a cell model of a near-zero-expansion lattice metal.

FIG. 2 is a schematic diagram of the near-zero-expansion lattice metal.

FIG. 3 is a thermal expansion curve of the near-zero-expansion lattice metal prepared in embodiment one.

### DETAILED DESCRIPTION OF THE EMBODIMENTS

The method of manufacturing of the present disclosure will be described in detail below with reference to the attached drawings. The examples given are only for explaining the present disclosure, not for limiting the scope of the present disclosure.

### Embodiment One

This embodiment involves design and manufacturing of a near-zero-expansion lattice metal with porosity of 58%.

The near-zero-expansion lattice metal is formed by extending a bimetallic lattice cell. The cell model of the bimetallic lattice is shown in FIG. 1, and bimetallic lattice cell has a three-dimensional structure with a truss structure embedded in a hexahedron. The diameter of the linkage of the extended near-zero-expansion lattice metal is 3 mm.

The manufacturing process of a near-zero-expansion lattice metal based on Invar alloy and NiTi alloy by laser coaxial powder feeding additive manufacturing includes the following steps.

Step 1: conducting process adaptability design on pore structure of the near-zero-expansion lattice metal and establishing a three-dimensional model of bimetallic lattice structure using three-dimensional design software based on process characteristics of laser coaxial powder feeding additive manufacturing.

Step 2, slicing the three-dimensional model of the bimetallic lattice structure established in step 1 with slicing software, and obtaining the cross-sectional data of the slices of the lattice metal. Different process parameters, including laser power, scanning speed, powder feeding airflow, overlapping ratio, single layer thickness, spot diameter, powder barrel selection, etc., are set in different regions in the same format.

The hexahedron structure slicing region corresponds to the first set of process parameters, and the fed powder material is Invar alloy powder. The truss structure slicing region corresponds to the second set of process parameters, and the fed powder material is NiTi alloy powder. The transition region at the connection position between the hexahedron and the truss structure corresponds to the third set of process parameters, and the fed powder material is mixed powder of Invar alloy and NiTi alloy, and the volumetric ratio of the Invar alloy powder and NiTi allow powder is 3:1.

Step 3, carrying out three-barrel controlled printing with the laser coaxial powder feeding additive manufacturing process under inert gas atmosphere.

The process parameters for the hexahedron structure slicing region are laser power being 1500 W, scanning speed being 800 mm/min, powder feeding airflow being 15 L/min and overlapping ratio being 70%.

The process parameters for the truss structure slicing region are laser power being 1200 W, scanning speed being 500 mm/min, powder feeding airflow being 15 L/min and overlapping rate being 70%.

The process parameters for the transition region are laser power being 2000 W, scanning speed being 500 mm/min, powder feeding airflow being 10 L/min and overlapping rate being 90%.

The single layer thickness for the three slicing regions is 0.5 mm, and the spot diameter is 3 mm.

Using laser coaxial powder feeding additive manufacturing equipment, two types of metal powders and the mixed powder thereof form the lattice structure via additive manufacturing according to the control parameters obtained by slicing and under the protection of inert gas. The two metal powders are Invar alloy powder and NiTi alloy powder with an average particle size of 20-53 μm, and an oxygen content in the printing chamber is less than or equal to 200 ppm.

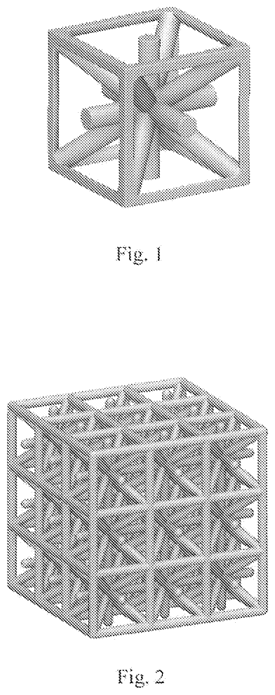

Step 4, carrying out solution treatment on the lattice metal obtained in Step 3. The temperature of the treatment is 1000° C. and the duration of the treatment is 3 hours. The obtained near-zero-expansion lattice metal is shown in FIG. 2.

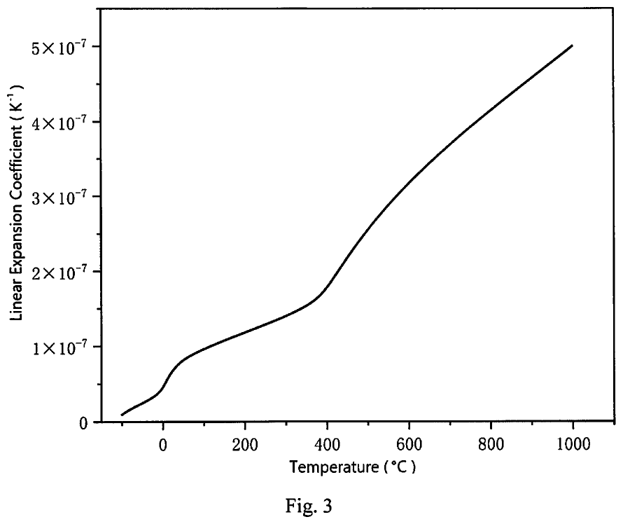

The thermal expansion coefficients of the near-zero-expansion lattice metal material manufactured according to this embodiment measured at various directions are approximately the same, which are all 0.25×1⁻⁶ K⁻¹. The curve of the thermal expansion coefficient at different temperatures is shown in FIG. 3.

### Embodiment Two

This embodiment involves design and manufacturing of a near-zero-expansion lattice metal with porosity of 75%.

The near-zero-expansion lattice metal is formed by extending a bimetallic lattice cell. The bimetallic lattice cell has a three-dimensional structure with a truss structure embedded in a hexahedron. The diameter of the linkage of the extended near-zero-expansion lattice metal is 2.5 mm.

The manufacturing process of a near-zero-expansion lattice metal based on Invar alloy and NiTi alloy by laser coaxial powder feeding additive manufacturing includes the following steps.

Step 1: conducting process adaptability design on pore structure of the near-zero-expansion lattice metal and establishing a three-dimensional model of a bimetallic lattice structure using three-dimensional design software based on process characteristics of laser coaxial powder feeding additive manufacturing.

Step 2, slicing the three-dimensional model of the bimetallic lattice structure established in step 1 with slicing software, and obtaining the cross-sectional data of the slices of the lattice metal. Different process parameters are set in different regions in the same format. The hexahedron and the truss structure are connected to set the transition region, and the mixed transition material is used to ensure metallurgical bonding of the interface. The transition material is mixed powder of Invar alloy and NiTi alloy, and the volumetric ratio of the Invar alloy powder and NiTi allow powder is 1:1.

Step 3, carrying out three-barrel controlled printing with the laser coaxial powder feeding additive manufacturing process under inert gas atmosphere.

The process parameters for the hexahedron structure slicing region are laser power being 2500 W, scanning speed being 1400 mm/min, powder feeding airflow being 25 L/min and overlapping ratio being 50%,

The process parameters for the truss structure slicing region are laser power being 2000 W, scanning speed being 1000 mm/min, powder feeding airflow being 25 L/min and overlapping rate being 50%.

The process parameters for the transition region are laser power being 2500 W, scanning speed being 600 mm/min, powder feeding airflow being 15 L/min and overlapping rate being 70%.

The single layer thickness for the three slicing regions is 0.6 mm, and the spot diameter is 3 mm.

Using laser coaxial powder feeding additive manufacturing equipment, two kinds of metal powders and the mixed powder thereof form the lattice structure via additive manufacturing according to the control parameters obtained by slicing and under the protection of inert gas. The two metal powders are Invar alloy powder and NiTi alloy powder with an average particle size of 20˜53 μm, and an oxygen content in the printing chamber is less than or equal to 200 ppm.

Step 4. carrying out solution treatment on the lattice metal obtained in Step 3. The temperature of the treatment is 1000° C. and the duration of the treatment is 1 hour.

The thermal expansion coefficients of the near-zero-expansion lattice metal material manufactured according to this embodiment measured at various directions are approximately the same, which are all 0.43×10⁻⁶ K⁻¹.

### Embodiment Three

This embodiment involves design and manufacturing of a near-zero-expansion lattice metal with porosity of 92%.

The near-zero-expansion lattice metal is formed by extending a bimetallic lattice cell. The cell model of the bimetallic lattice is shown in FIG. 1, and bimetallic lattice cell has a three-dimensional structure with a truss structure embedded in a hexahedron. The diameter of the linkage of the extended near-zero-expansion lattice metal is 1 mm.

The manufacturing process of a near-zero-expansion lattice metal based on Invar alloy and NiTi alloy by laser coaxial powder feeding method includes the following steps.

Step 1: conducting process adaptability design on pore structure of the near-zero-expansion lattice metal and establishing a three-dimensional model of a bimetallic lattice structure using three-dimensional design software based on process characteristics of laser coaxial powder feeding additive manufacturing.

Step 2, slicing the three-dimensional model of the bimetallic lattice structure established in step 1 with slicing software, and obtaining the cross-sectional data of the slices of the lattice metal. Different process parameters are set in different regions in the same format. The hexahedron and the truss structure are connected to set the transition region, and the mixed transition material is used to ensure metallurgical bonding of the interface. The transition material is mixed powder of Invar alloy and NiTi alloy, and the volumetric ratio of the Invar alloy powder and NiTi allow powder is 2:1.

Step 3, carrying out three-barrel controlled printing with the laser coaxial powder feeding additive manufacturing process under the inert gas atmosphere.

The process parameters for the hexahedron structure slicing region are laser power being 1000 W, scanning speed being 200 mm/min, powder feeding airflow being 5 L/min and overlapping ratio being 50%.

The process parameters for the truss structure slicing region are laser power being 800 W, scanning speed being 150 mm/min, powder feeding airflow being 5 L/min and overlapping ratio being 50%.

The process parameters for the transition region are laser power being 1000 W, scanning speed being 50 mm/min, powder feeding airflow being 5 L/min and overlapping rate being 70%.

The single layer thickness for the three slicing regions is 0.7 mm, and the spot diameter is 0.8 mm.

Using laser coaxial powder feeding additive manufacturing equipment, two kinds of metal powders and the mixed powder thereof form the lattice structure via additive manufacturing according to the control parameters obtained by slicing and under the protection of inert gas. The two metal powders are Invar alloy powder and NiTi alloy powder with an average particle size of 20˜53 μm. and an oxygen content in the printing chamber is less than or equal to 200 ppm.

Step 4, carrying out solution treatment on the lattice metal obtained in Step 3. The temperature of the treatment is 1000° C. and the duration of the treatment is 10 hours.

The thermal expansion coefficients of the near-zero-expansion lattice metal material manufactured according to this embodiment measured at various directions are approximately the same, which are all 0.37×10⁻⁶ K⁻¹.

### Comparative Example

This experiment is a comparative example of embodiment three; In this comparative example, in the process of designing and printing a near-zero-expansion lattice metal with porosity of 92%, no transition region is set at the connection between the hexahedron and truss structure. Other parameters are completely consistent with embodiment three, and the specific experimental steps are as follows.

Step 1: conducting process adaptability design on pore structure of the near-zero-expansion lattice metal and establishing a three-dimensional model of a bimetallic lattice structure using three-dimensional design software based on process characteristics of laser coaxial powder feeding method.

Step 2, slicing the three-dimensional model of the bimetallic lattice structure established in step 1 with slicing software, and obtaining the cross-sectional data of the slices of the lattice metal. Different process parameters are set in different regions in the same format.

Step 3, carrying out three-barrel controlled printing with the laser coaxial powder feeding additive manufacturing process under the inert gas atmosphere.

The process parameters for the hexahedron structure slicing region are laser power being 1000 W, scanning speed being 200 mm/min, powder feeding airflow being 5 L/min and overlapping ratio being 50%.

The process parameters for the truss structure slicing region are laser power being 800 W, scanning speed being 150 mm/min, powder feeding airflow being 5 L/min and overlapping rate being 50%.

The single layer thickness for the two slicing regions is 0.7 mm, and the spot diameter is 0.8 mm.

Using laser coaxial powder feeding additive manufacturing equipment, two kinds of metal powders form the lattice structure via additive manufacturing according to the control parameters obtained by slicing and under the protection of inert gas. The two metal powders are Invar alloy powder and NiTi alloy powder with an average particle size of 20˜53 μm, and an oxygen content in the printing chamber is less than or equal to 200 ppm.

Step 4, carrying out solution treatment on the lattice metal obtained in Step 2. The temperature of the treatment is 1000° C. and the duration of the treatment is 10 hours.

The lattice metal material prepared according to this experimental method do not have near-zero-expansion characteristic, and the thermal expansion coefficient is 4.7×10⁻⁶ K⁻¹. Obvious cracks can be seen at the interface between the two metals, which indicates that the interface between the two metals does not undergo a finished metallurgical bonding, and the compressive mechanical properties are also poor.

The above embodiments are only for explaining the technical concept and characteristics of the present disclosure, and the purpose of the above embodiments is to enable people familiar with the technology to understand the content of the present disclosure and implement it accordingly, without limiting the protection scope of the present disclosure. All equivalent changes or modifications made according to the spirit of the present disclosure should be included in the protection scope of the present disclosure.

1. A near-zero-expansion lattice metal based on additive manufacturing, wherein the lattice metal has a three-dimensional bimetallic lattice structure and is formed by extending a bimetallic lattice cell, the bimetallic lattice cell has a three-dimensional structure with a truss structure embedded in a hexahedron and has a capability of extending in three spatial directions, a connection position between the hexahedron and the truss structure is provided with a transition region, and the contour of the transition region is not larger than a linkage diameter of the cell, the hexahedron is made of one type of metal, the truss structure is made of another type of metal, and the transition region is made of a mixture of the two types of metal, a ratio of linear expansion coefficients of the two types of metals is not less than 5, an interface between the two metals has no gap, and the two type of metals are metallurgically bonded at the interface; a laser coaxial powder feeding additive manufacturing process is adopted to manufacture the lattice metal, and
wherein the lattice metal has a near-zero-expansion characteristic in a wide temperature range. the wide temperature range is a temperature range of −100° C.˜1000° C., and the near-zero-expansion characteristic is a characteristic that an absolute value of the thermal expansion coefficient is not higher than 0.5×10⁻⁶ K⁻¹ in the wide temperature range; the lattice metal has an isotropic thermodynamic property shown by same near-zero-expansion characteristics in the three spatial directions.

2. The near-zero-expansion lattice metal based on additive manufacturing according to claim 1, wherein the hexahedron is made of Invar alloy and the truss structure is made of NiTi alloy.

3. (canceled)

4. The near-zero-expansion lattice metal based on additive manufacturing according to claim 1, wherein the lattice metal has a porosity of 58%˜92% and a linkage diameter of 1˜3 mm.

5. A method for manufacturing the lattice metal according to claim 1, wherein the method comprises the following steps:
step 1. carrying out process adaptability design on pore structure for the near-zero-expansion lattice metal with three-dimensional design software, and establishing a three-dimensional model of the bimetallic lattice structure;
step 2, slicing the three-dimensional model of the near-zero-expansion lattice metal established in step 1 with slicing software, and setting different process parameters for different regions in a same format, wherein, for the hexahedron structure slicing region, a first set of process parameters is adopted and the fed powder material is Invar alloy powder; for the truss structure slicing region, a second set of process parameters is adopted and the fed powder material is NiTi alloy powder; for the transition region between hexahedron and truss structure, a third process parameter is adopted and the fed powder material is the mixed powder of Invar alloy and NiTi alloy;
step 3, carrying out three-barrel controlled printing with the laser coaxial powder feeding additive manufacturing process in an inert atmosphere,
wherein process parameters for the hexahedron structure slicing region are laser power being 1000˜2500 W, scanning speed being 200˜1400 mm/min, powder feeding airflow being 5˜25 L/min and overlapping rate being 50%˜70%;
the process parameters for the truss structure slicing region are laser power being 800˜2000 W, scanning speed being 150˜1000 mm/min, powder feeding airflow being 5˜25 L/min and overlapping ratio being 50%˜70%;
the process parameters for the transition region are laser power being 1000˜2500 W, scanning speed being 50˜600 mm/min, powder feeding airflow being 5˜15 L/min and overlapping ratio 70%˜90%;
the single layer thickness for the three regions is 0.5˜0.7 mm, and the spot diameter is 0.8˜3 mm;
step 4, carrying out solution treatment on the near-zero-expansion lattice metal obtained in step 3, wherein the temperature for treatment is 1000° C., and the duration for treatment is 1˜10 hours.

6. The method for manufacturing the lattice metal according to claim 5, wherein in step 2, the average particle size of the Invar alloy powder and the NiTi alloy powder is 20˜53 μm; in the mixed powder, the volumetric ratio of the invar alloy and the NiTi alloy is 1:1˜3:1.

7. The method for manufacturing the lattice metal according to claim 5, wherein in step 3, multi-channel powder design and control software is used to conduct the feeding control of the three types of powders and the automatic switching of the barrels, so as to achieve associated selection control of powder channels and manufacture the near-zero-expansion lattice metal.

8. An application of the near-zero-expansion lattice metal manufactured using the method according to claim 5, wherein the lattice metal is used to manufacture a thermally stable structural component in the aeronautics and aerospace field under an extreme environmental service condition.

9. The application of the lattice metal according to claim 8, wherein the thermally stable structural component is a camera bracket of a navigation satellite, a deep space exploration satellite or aeronautics and aerospace equipment.
